(19) United States
(12) Patent Application Publication
(10) Pub. No.: US 2016/0064799 A1
(43) Pub. Date: Mar. 3, 2016

(54) RADIATOR FRAME HAVING ANTENNA PATTERN AND METHOD OF MANUFACTURING THE SAME

(71) Applicant: Samsung Electro-Mechanics Co., Ltd., Suwon-si (KR)

(72) Inventors: Dae Seong JEON, Suwon-si (KR); Sung Eun CHO, Suwon-si (KR); Hyun Sam MUN, Suwon-si (KR)

(73) Assignee: SAMSUNG ELECTRO-MECHANICS CO., LTD., Suwon-si (KR)

(21) Appl. No.: 14/837,013

(22) Filed: Aug. 27, 2015

(30) Foreign Application Priority Data
Sep. 3, 2014 (KR) 10-2014-0117285

(51) Int. Cl. H01Q 1/24; H01Q 9/04

(52) U.S. Cl. CPC H01Q 1/241; H01Q 9/04

(57) ABSTRACT

A radiator frame having an antenna pattern and a method of manufacturing the same are provided. The radiator frame includes a molded frame having a connection terminal part extending therethrough, the connection terminal part being exposed on a first surface of the molded frame and a second surface of the molded frame, and an antenna pattern portion patterned on the first surface of the molded frame and connected to the connection terminal part. The connection terminal part includes a contact expansion part extending along the first surface of the molded frame, a connection portion extending through the molded frame from one end of the contact expansion part to the second surface of the molded frame, and a terminal portion extending along the second surface of the molded frame from one end of the connection portion.

### CROSS-REFERENCE TO RELATED APPLICATION(S)

This application claims the benefit of Korean Patent Application No. 10-2014-0117285 filed on Sep. 3, 2014, in the Korean Intellectual Property Office, the entire disclosure of which is incorporated herein by reference for all purposes.

### BACKGROUND

1. Field

The following description relates to a radiator frame having an antenna pattern and a method of manufacturing the same.

2. Description of Related Art

Mobile communications terminals such as mobile phones, personal digital assistants (PDAs), GPS navigation devices, and laptop computers supporting wireless communications are essential devices in modern society. Mobile communications terminals have been developed to allow for communications to be undertaken using schemes such as code division multiple access (CDMA), wireless local area network (WLAN), global system for mobile communications (GSM), digital multimedia broadcasting (DMB), and the like. One of the most important components that enables these schemes is an antenna.

There have been problems in mobile communications terminals in that an exterior type antenna is vulnerable to external impacts and an interior type antenna increases the volume of the terminal. In order to solve these problems, a significant amount of research into technology of integrating an antenna into mobile communications terminals has been conducted in recent years.

A method in which a radiator frame is formed by injection-molding a molded frame to embed a radiator therein has been used in the related art. However, in a case in which the radiator including an antenna pattern portion and a connection terminal part is embedded in an injection-molded frame, manufacturing yield is decreased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a radiator frame may include a molded frame having a connection terminal part extending therethrough, the connection terminal part being exposed on a first surface of the molded frame and a second surface of the molded frame, and an antenna pattern portion formed on the first surface of the molded frame and connected to the connection terminal part. The connection terminal part may include a contact expansion part extending along the first surface of the molded frame, a connection portion extending through the molding frame from one end of the contact expansion part to the second surface of the molded frame, and a terminal portion extending along the second surface of the molded frame from one end of the connection portion.

The molded frame may include a pattern groove in which the antenna pattern portion is disposed.

An upper surface of the antenna pattern portion may be disposed on a same plane as the first surface of the molded frame.

At least a portion of the contact expansion part may be exposed at a bottom of the pattern groove.

The antenna pattern portion may be connected to at least a portion of the contact expansion part.

The antenna pattern portion may overlap the contact expansion part outside a portion of the antenna pattern portion overlapping the connection portion in a thickness direction of the radiator frame.

The connection terminal part may be formed in a shape of [symbol] .

The connection terminal part may be formed in a shape of [symbol] .

The antenna pattern portion may be constructed of a printed or plated material.

According to another general aspect, a method of manufacturing a radiator frame may include: disposing a connection terminal part in an internal space of an upper portion of a mold or a lower portion of a mold; forming the radiator frame by coupling the upper mold portion and the lower mold portion to each other and providing a resin in the internal space to form a molded frame such that the connection terminal part is embedded in the molded frame and exposed on a first surface of the molded frame and a second surface of the molded frame; and forming an antenna pattern portion to be exposed on the first surface of the molded frame and connected to the connection terminal part.

The connection terminal part may include a contact expansion part extending along the first surface of the molded frame, a connection portion extending through the molded frame from one end of the contact expansion part to the second surface of the molded frame; and a terminal portion extending along the second surface of the molded frame from one end of the connection portion.

The connection terminal part may be formed by punching a conductive metal base plate or connecting pieces of a conductive material.

Forming the antenna pattern portion may include printing or patterning a conductive ink on the first surface of the molded frame, or plating the antenna pattern portion on the first surface of the molded frame.

Other features and aspects will be apparent from the following detailed description, the drawings, and the claims.

### BRIEF DESCRIPTION OF DRAWINGS

FIG. 1 is a schematic perspective view of a configuration in which a radiator frame is coupled to a case of a mobile communications terminal, according to an example.

FIG. 2 is an exploded perspective view of an example of the mobile communications terminal manufactured using the radiator frame.

FIG. 3 is an exploded perspective view of an example of a radiator provided in the radiator frame, according to an example.

FIG. 4 is a schematic perspective view of the radiator frame according to an example.

FIG. 5A is a schematic cross-sectional view taken along line A-A′ of FIG. 4, which illustrates a form before an antenna pattern part is provided.

FIG. 5B is a schematic cross-sectional view taken along line A-A′ of FIG. 4, which illustrates a form after the antenna pattern part is provided.

FIG. 6 is a schematic cross-sectional view showing a connection terminal part disposed between mold portions and a resin material filled between the mold portions in a method of manufacturing the radiator frame, according to an example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

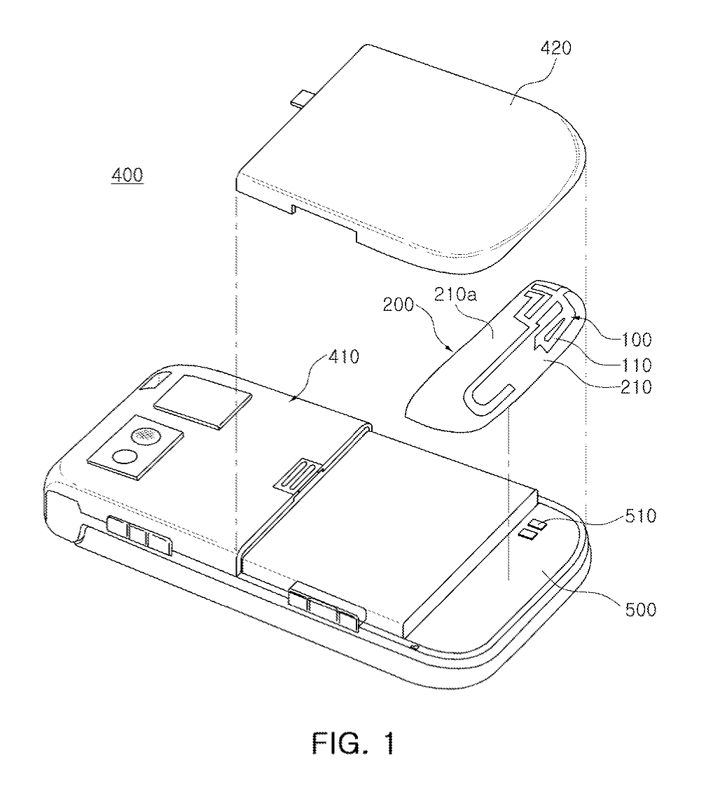

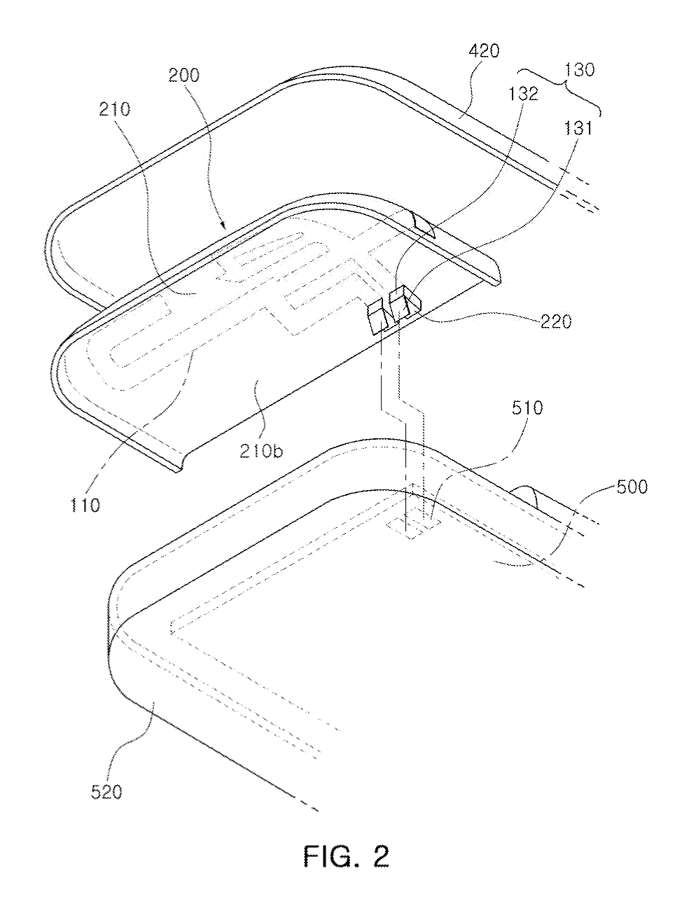

FIG. 1 is a schematic perspective view of a configuration in which a radiator frame 200 is coupled to a case of a mobile communications terminal 400, according to an example. FIG. 2 is an exploded perspective view of an example of the mobile communications terminal manufactured 400 by using the radiator frame 200. While the examples disclosed herein describe the radiator frame 200 provided in the mobile communications terminal 400, the radiator frame 200 may be provided in other types of electronic devices.

Referring to FIGS. 1 and 2, a mobile communications terminal 400, includes a case 410 forming an external shape and a battery cover 420 covering a battery mounting part (not shown) and a radiator frame 200. The radiator frame 200 may be provided by embedding a connection terminal part 130 in a molded frame 210 and then forming an antenna pattern portion 110 such that the antenna pattern portion 110 is connected to the connection terminal part 130 and exposed on a first surface 210a of the molded frame 210. Further, the connection terminal part 130 may include a terminal portion 131 exposed on a second surface 210b of the molded frame 210, and a connection portion 132 molded in the molded frame 210 and connecting the terminal portion 131 and the antenna pattern portion 110.

The connection terminal part 130 may be connected to a terminal 510 of a circuit board 500 such that the radiator frame 200, when mounted in the mobile communications terminal 400, may implement antenna performance in the mobile communications terminal 400.

The terminal portion 131 of the connection terminal part 130 may be in elastic contact with the terminal 510 in order to provide a reliable connection with the terminal 510. However, the terminal portion 131 is not limited to the above-mentioned elastic contact structure with the terminal 510. For example, the terminal portion 131 may have any structure as long as it may be in contact with the terminal 510.

When the radiator frame 200 is mounted in the mobile communications terminal 400 and is not covered by the battery cover 420, the antenna pattern portion 110 may be externally exposed. Thus, a coating layer (not illustrated) may be formed on the antenna pattern portion 110.

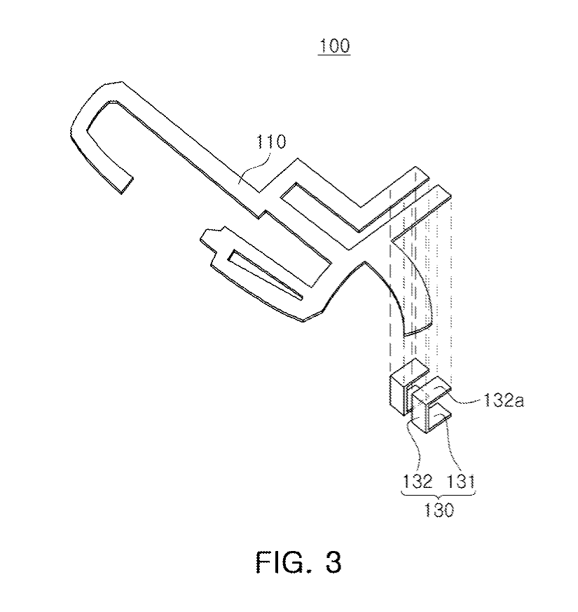

FIG. 3 is an exploded perspective view of the radiator 100 provided in the radiator frame 200, according to an example.

Referring to FIG. 3, the radiator 100 includes the antenna pattern portion 110, and the connection terminal part 130 including the terminal portion 131 and the connection portion 132. In addition, the antenna pattern portion 110 and the connection terminal part 130 may be formed as separate members.

The radiator frame 200 may be constructed by injection-molding the molded frame 210 to embed the connection terminal part 130 therein such that an end portion of the connection portion 132 of the connection terminal part 130 is exposed on the first surface 210a of the molded frame 210 and the terminal portion 131 is exposed on the second surface 210b of the molded frame 210, and then forming the antenna pattern portion 110 on the first surface 210. The antenna pattern portion 110 may be formed on the first surface 210a by various methods.

The connection terminal part 130 may transmit a signal received by the antenna pattern portion 110 to the mobile communications terminal 400, or transmit a signal to be transmitted from the mobile communications terminal 400 to the antenna pattern portion 110. The connection terminal part 130 may be formed, for example, by punching and bending a plate made of a conductive material such as aluminum, copper, or the like, or connecting pieces of conductive material to each other, and may have a shape of ‘ [symbol] ’ including the connection portion 132 and the terminal portion 131. Alternatively, the connection terminal part 130 may have a shape of ‘ [symbol] ’ or a shape of ‘ [symbol] ’ including a contact expansion part 132a extending from the connection portion 132 in a direction that is the same as a direction in which the terminal portion 131 extends, or in a direction that is opposite to a direction in which the terminal portion 131 extends.

In addition, the antenna pattern portion 110 may be constructed of a conductive material such as aluminum, copper, or the like, to receive an external signal and transfer the external signal to a signal processing device of the mobile communications terminal 400. The antenna pattern portion 110 may be formed in a meander line in order to receive external signals of various bands. The antenna pattern portion 110 may be formed by punching and bending a plate, or by connecting pieces of material to each other, similar to the connection terminal part 130. Alternatively, the antenna pattern portion 110 may be formed by printing or patterning conductive ink on the molded frame 210.

In addition, although the connection terminal part 130 and the antenna pattern portion 110 are separately manufactured, they may be electrically connected to each other in the radiator frame 200, which is a final product.

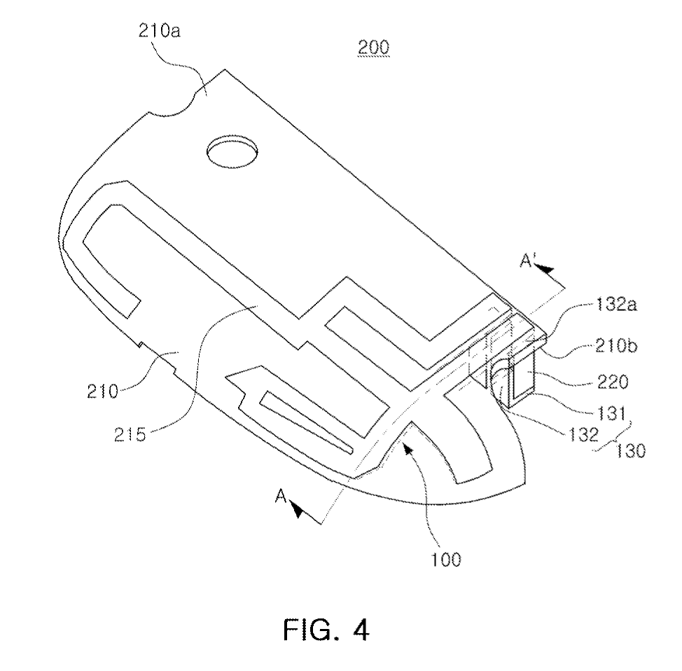

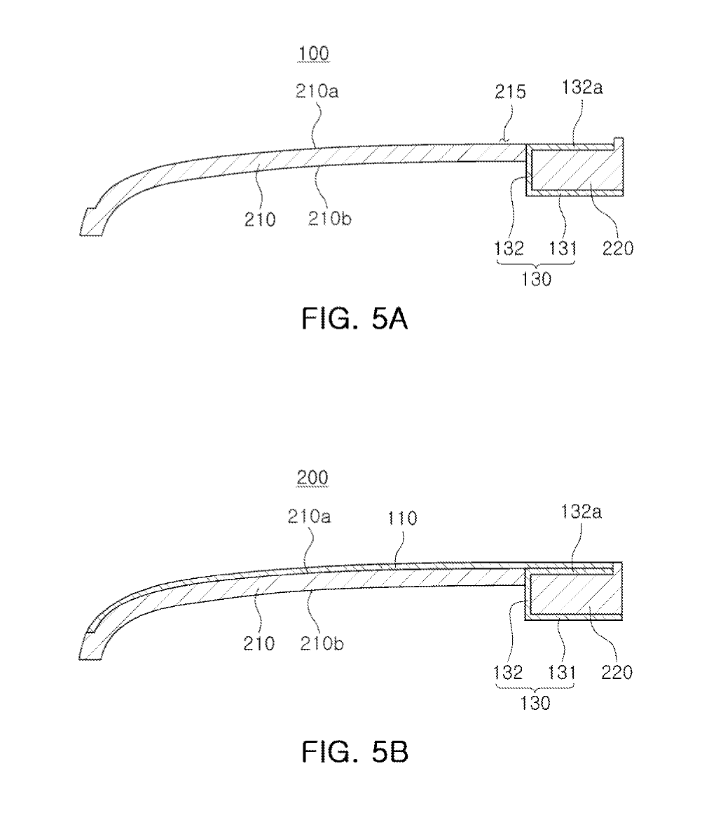

FIG. 4 is a schematic perspective view of the radiator frame 200 according to an example. FIG. 5A is a schematic cross-sectional view taken along part A-A′ of FIG. 4, which illustrates a form before an antenna pattern portion 110 is provided. FIG. 5B is a schematic cross-sectional view taken along part A-A′ of FIG. 4, which illustrates a form after the antenna pattern portion 110 is provided.

Referring to FIGS. 4A through 5B, the radiator frame 200, according to an example, includes the antenna pattern portion 110, the connection terminal part 130, and the molded frame 210. Since the configurations of the antenna pattern portion 110 and the connection terminal part 130 have been described above in detail, a description thereof will be omitted in the description of FIGS. 4 through 5B.

The molded frame 210 may be manufactured by injection-molding the molded frame 210 around the connection terminal part 130 such that the terminal part 130 is embedded in the molded frame 210. In this case, the terminal portion 131 may be arranged to be exposed on the second surface 210b of the molded frame 210, and the connection portion 132 may be arranged so that a first end portion thereof is connected to the terminal portion 131 and a second end portion thereof is exposed on the first surface 210a of the molded frame 210. In this case, the terminal portion 131 may have a shape supported by a supporting part 220 of the molded frame 210.

More specifically, the second end portion of the connection portion 132 may be exposed to a pattern groove 215 included in the first surface 210a of the molded frame 210. In addition, in a case in which the second end portion of the connection portion 132 includes the contact expansion part 132a, one surface of the contact expansion part 132a may be exposed to the pattern groove 215. The pattern groove 215 may have the same shape as that of the antenna pattern portion 110, such that the antenna pattern portion may be secured or formed in the pattern groove 215.

In addition, the molded frame 210 may be an injection structure, and the pattern groove 215 may be formed in the surface 210a of the molded frame 210 during the injection-molding process. Thus, as indicated above, when the antenna pattern portion 110 is secured in the pattern groove 215, the antenna pattern portion 110 may be exposed to the first surface 210a of the molded frame 210.

Further, the antenna pattern portion 110 may be secured in the pattern groove 215 such that the antenna pattern portion 110 is connected to the second end portion of the connection portion 132, or is in surface contact with one surface of the contact expansion part 132a.

In the case in which the antenna pattern portion 110 is formed by punching and bending the conductive plate made of a conductive material such as aluminum, copper, or the like, or formed by connecting the pieces of conductive material to each other, the antenna pattern portion 110 may be attached to the pattern groove 215 by pressing the antenna pattern portion 110 in the pattern groove 215 or by bonding the antenna pattern portion 110 within the pattern groove 215 using an adhesive. In a case of bonding using the adhesive, the antenna pattern portion 110 and the connection portion 132 may be attached to each other by conductive adhesive.

In addition, the antenna pattern portion 110 may be formed by printing or patterning (transferring) conductive ink in the pattern groove 215 of the molded frame 210. In this case, the printing or the patterning may be performed one time or any number of times required to sufficiently form the antenna pattern portion 110.

Alternatively, the antenna pattern portion 110 may be manufactured by performing an insert-injection for the connection terminal part 130 using a resin for laser direct structuring (LDS) as a resin material during a process of manufacturing the molded frame 210, performing a laser machining on the first surface 210a of the molded frame 210 along a desired shape (three-dimensional shape) of the antenna pattern portion 110 to form the pattern groove 215 having a shape of the antenna pattern portion 110, and then plating an interior of the pattern groove 215. Of course, in this case, the antenna pattern portion 110 and the connection terminal part 130 may be electrically connected to each other.

A metal, conductive ink, or plating pattern of the antenna pattern portion 110 may be formed of a different material than a material of the connection terminal part 130. In this case, in order to ensure reliability of the connection between different materials, a portion in the molded frame 210 at which the antenna pattern portion 110 and the connection terminal part 130 are connected to each other may be designed to have a concave shape which is inwardly retracted (so that an injection shape falls downwardly), and a portion of the antenna pattern portion 110 connected to the connection terminal part 130 may be formed in a concave shape which is retracted from the molded frame 210 to be insensitive to external shocks. In addition, a portion of the concave shape of the antenna pattern portion 110 may be filled with a protecting material such as separate silicon, or the like.

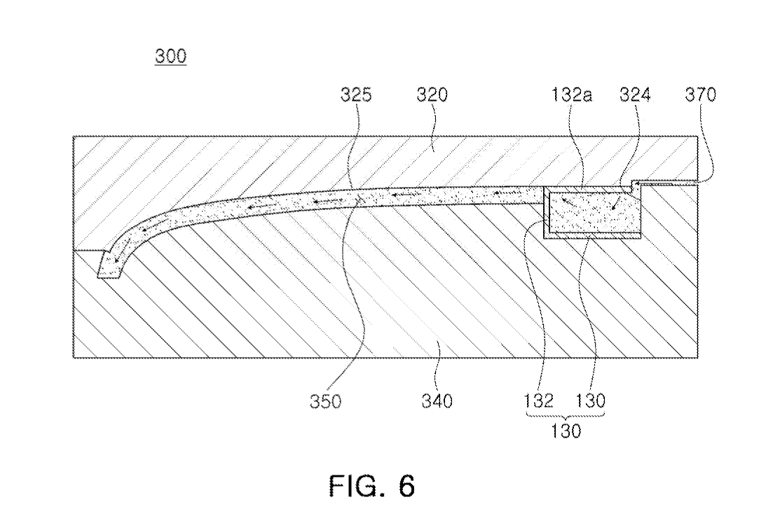

FIG. 6 is a schematic cross-sectional view illustrating the connection terminal part 130 disposed between an upper mold portion 320 and a lower mold portion 340 of a mold 300, and a resin material filled between the mold portions 320 and 340 in a method of manufacturing the radiator frame 200 according to an example.

Referring to FIG. 6, a method of manufacturing the molded frame 210, according to an example, may include an operation of providing the connection terminal part 130 by punching a conductive metal base plate to form the connection terminal part 130; an operation of disposing the connection terminal part 130 in an arrangement part 324, which is a portion in which the supporting part 220 is formed in an internal space 350 of the upper mold portion 320 or the lower mold portion 340; and an operation of coupling the upper mold portion 320 and the lower mold portion 340 to each other, and filling a resin material into the internal space 350 of the upper mold portion 320 or the lower mold portion 340 to form the molded frame 210 burying the connection terminal part 130 therein while exposing the connection terminal part 130 to the first surface 210a and the second surface 210b of the molded frame 210.

The upper mold portion 320 may be configured such that a protrusion part 325 having the same shape as that of the antenna pattern portion 110 protrudes into the internal space 350. The pattern groove 215 may be formed in the molded frame 210 by the protrusion part 325.

During the process of manufacturing the molded frame 210 according to the example described above, the arrangement part 324 may be formed in the internal space 350 formed by the mold portions 320 and 340. In addition, in an example in which the connection terminal part 130 is provided in the arrangement part 324, an in-mold injection may be performed so that the supporting part 220 supporting the terminal portion 131 is formed. Thereby, the in-mold injection may be easily performed and reliability may be improved.

According to the example embodiments disclosed herein, a radiator frame having an antenna, and a method of manufacturing the same, allow for an improved manufacturing yield.

As a non-exhaustive example only, a terminal/electronic device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A radiator frame comprising:
a molded frame comprising a connection terminal part extending therethrough, the connection terminal part being exposed on a first surface of the molded frame and a second surface of the molded frame; and
an antenna pattern portion formed on the first surface of the molded frame and connected to the connection terminal part,
wherein the connection terminal part comprises a contact expansion part extending along the first surface of the molded frame, a connection portion extending through the molded frame from one end of the contact expansion part to the second surface of the molded frame, and a terminal portion extending along the second surface of the molded frame from one end of the connection portion.

2. The radiator frame of claim 1, wherein the molded frame comprises a pattern groove in which the antenna pattern portion is disposed.

3. The radiator frame of claim 2, wherein an upper surface of the antenna pattern portion is disposed on a same plane as the first surface of the molded frame.

4. The radiator frame of claim 2, wherein at least a portion of the contact expansion part is exposed at a bottom of the pattern groove.

5. The radiator frame of claim 1, wherein the antenna pattern portion is connected to at least a portion of the contact expansion part.

6. The radiator frame of claim 1, wherein the antenna pattern portion overlaps the contact expansion part outside a portion of the antenna pattern portion overlapping the connection portion in a thickness direction of the radiator frame.

7. The radiator frame of claim 1, wherein the connection terminal part is formed in a shape of [symbol] .

8. The radiator frame of claim 1, wherein the connection terminal part is formed in a shape of [symbol] .

9. The radiator frame of claim 1, wherein the antenna pattern portion is constructed of a printed or plated material.

10. A method of manufacturing a radiator frame, the method comprising:
disposing a connection terminal part in in an internal space of an upper portion of a mold or lower portion of the mold;
forming the radiator frame by coupling the upper mold portion and the lower mold portion to each other and providing a resin material into the internal space to form a molded frame such that the connection terminal part is embedded in the molded fame and exposed on a first surface of the molded frame and a second surface of the molded frame; and
forming an antenna pattern portion to be exposed on a first surface of the molded frame and connected to the connection terminal part.

11. The method of claim 10, wherein the connection terminal part comprises:
a contact expansion part extending along the first surface of the molded frame;
a connection portion extending through the molded frame from one end of the contact expansion part to the second surface of the molded frame; and
a terminal portion extending along the second surface of the molded frame from one end of the connection portion.

12. The method of claim 10, comprising forming the connection terminal part by punching a conductive metal base plate or connecting pieces of a conductive material.

13. The method of claim 10, wherein forming the antenna pattern portion comprises printing or patterning a conductive ink on the first surface of the molded frame, or plating the antenna pattern portion on the first surface of the molded frame.
